(19) United States
(12) Patent Application Publication
(10) Pub. No.: US 2026/0265514 A1
(43) Pub. Date: Sep. 10, 2026

(54) SOFT POLYPROPYLENE COMPOSITION CONTAINING A RECYCLED MATERIAL

(71) Applicant: Basell Poliolefine Italia S.r.l., Milano (IT)

(72) Inventors: Monica Galvan, Ferrara (IT); Eleonora Ciaccia, Ferrara (IT)

(73) Assignee: Basell Poliolefine Italia S.r.l., Milano (IT)

(21) Appl. No.: 19/164,825

(22) PCT Filed: Mar. 4, 2024
(86) PCT No.: PCT/EP2024/055530

§ 371 Date: Sep. 12, 2025

(30) Foreign Application Priority Data
Mar. 14, 2023 (EP) 23161646.7

(51) Int. Cl. C08L 23/16; C08J 5/18; E04D 5/08

(52) U.S. Cl. CPC C08L 23/16; C08J 5/18; E04D 5/08; C08J 2323/16; C08J 2423/06; C08J 2423/14; C08L 2203/16; C08L 2205/025; C08L 2205/03; C08L 2207/20

(57) ABSTRACT

A polyolefin composition (I) made from or containing:
(A) 65-95 wt. % of a polypropylene composition, having MFR(A) of 0.2-1.2 g/10 min, made from or containing:
   15-40 wt. % of a polymer fraction (a) made from a propylene and having solubility in xylene at 25° C.≤10.0 wt. %; and
   60-85 wt. % of a polymer fraction (b) i) made from or containing a copolymer of ethylene with a comonomer selected from propylene, a CH₂═CHR alpha-olefin, or both, ii) containing ethylene in amount≤40 wt. %, and iii) having solubility in xylene at 25° C.≥60 wt. %,
and
(B) 5-35 wt. % of a recycled ethylene polymer, having a density≥0.94 g/cm³ and MFR(B) of 0.05-10.0 g/10 min.

### FIELD OF THE INVENTION

In general, the present disclosure relates to the field of chemistry. More specifically, the present disclosure relates to polymer chemistry. In particular, the present disclosure relates to a polyolefin composition made from or containing a recycled material and extruded articles made therefrom.

### BACKGROUND OF THE INVENTION

In some instances, polypropylene compositions made from or containing a polypropylene matrix, into which elastomeric particles of an ethylene/alpha-olefin copolymer are dispersed, have thermoplastic behavior and elastic properties. In some instances, the polypropylene compositions also have a balance of additional properties, like softness, stress resistance and weldability. In some instances, the polypropylene compositions are used in roofing applications.

Despite performance and recyclability, polypropylene compositions have given rise to concerns of sustainability because the production of virgin polypropylene compositions is based on the use of non-renewable feedstocks.

In some instances, attempts to mitigate the concerns include replacing, at least partially, virgin polypropylene compositions with recycled plastic materials derived from post-consumer or post-industrial waste.

### SUMMARY OF THE INVENTION

In a general embodiment, the present disclosure provides a polypropylene composition (I) according to the appended independent claims, alternatively according to a claim directly or indirectly depending from the independent claims.

In some embodiments, the present disclosure provided an extruded article made from or containing the polypropylene composition (I). In some embodiments, the extruded article is a film or a sheet.

While multiple embodiments are disclosed, other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified.

In the present disclosure, the total weight of a polymer composition sums up to 100% by weight, unless otherwise specified.

In the present disclosure, when the term “comprising” is referred to a polymer, a plastic material, a polymer composition, mixture or blend, the term should be construed to mean “comprising or consisting essentially of”.

In the present disclosure, the term “consisting essentially of” means that, in addition to the specified components, the polymer, the plastic material, the polymer composition, the polymer mixture, or the polymer blend may be further made from or containing other components, provided that the characteristics of the material are not materially affected by the presence of the other components. In some embodiments, the other components are selected from the group consisting of catalyst residues, antistatic agents and processing aids.

In the present disclosure, the term “copolymer” is referred to a polymer deriving from the intentional polymerization of at least two different comonomers, that is, the term “copolymer” includes terpolymers.

In the present disclosure, the terms “pre-consumer waste” and “post-industrial waste” are synonyms and refer to a material diverted from the waste stream originating from a manufacturing process. In some embodiments, the materials are selected from the group consisting of material trimmings, faulty items, overstock raw materials, and excess inventory.

In the present disclosure, the term “post-consumer waste” refers to a material that is discarded after use by a final consumer.

In the present disclosure, a “film” refers to a thin layer of material having thickness equal to or lower than 2000 μm.

In the present disclosure, a “sheet” refers to a layer of material more than 2000 μm thick.

In some embodiments, the present disclosure provides a polyolefin composition (I) made from or containing:
(A) from 65 to 95% by weight, alternatively from 70 to 93% by weight, alternatively from 75 to 90% by weight, of a polypropylene composition,
having a melt flow rate MFR(A) (ISO 1133-1:2011, 230° C./2.16 kg) ranging from 0.2 to 1.2 g/10 min, and
made from or containing:
a) from 15 to 40% by weight, alternatively from 25 to 35% by weight, of a polymer fraction (a)
i) made from or containing a propylene polymer selected from a propylene homopolymer, a propylene copolymer and combinations thereof,
   wherein the propylene copolymer containing up to and including 15.0% by weight of units derived from a comonomer selected from ethylene, a CH₂═CHR alpha-olefin, where R is a linear or branched C2-C8 alkyl group, and combinations thereof, based on the weight of the polymer fraction (a), and
ii) having solubility in xylene at 25° C. XS(a) equal to or lower than 10.0% by weight, based on the weight of the polymer fraction (a); and
b) from 60 to 85% by weight, alternatively from 65 to 75% by weight of a polymer fraction (b)
i) made from or containing a copolymer of ethylene with a comonomer selected from propylene, a CH₂═CHR alpha-olefin, where R is a linear or branched C2-C8 alkyl group, and combinations thereof,
   wherein the copolymer containing an amount of units deriving from ethylene equal to or lower than 40% by weight, based on the weight of the polymer fraction (b), and
ii) having solubility in xylene at 25° C. XS(b) equal to or greater than 60% by weight, based on the weight of the polymer fraction (b),
wherein the amounts of fractions (a) and (b) are based on the sum of the weights of fraction (a)+fraction (b); and
(B) from 5 to 35% by weight, alternatively from 7 to 30% by weight, alternatively from 10 to 25% by weight, of a recycled ethylene polymer, having a density equal to or greater than 0.94 g/cm³ and a MFR(B) ranging from 0.05 to 10.0 g/10 min. (ISO 1133-1:2011, 190° C./2.16 kg),
wherein the amounts of (A) and (B) are based on the total weight of (A)+(B).

In some embodiments, the polyolefin composition (I) is made from or containing the individual components in various combinations.

In some embodiments, the polymer fraction (a) has at least one of the following features:
being made from or containing a propylene copolymer containing from 0.5 to 10.0% by weight, alternatively from 1.0 to 8.0% by weight, alternatively from 2.5 to 5.0% by weight, of a comonomer selected from ethylene, a CH₂═CHR alpha-olefin, where R is a linear or branched C2-C8 alkyl group, and combinations thereof, based on the weight of the fraction (a); or
a melt flow rate MFR(a) (ISO 1133-1:2011, 230° C./2.16 kg) ranging from 10 to 50 g/10 min, alternatively from 15 to 40 g/10 min, alternatively from 20 to 35 g/10 min.

In some embodiments, the comonomer is selected from the group consisting of ethylene, butene-1, hexene-1, octene-1, 3-methyl-1-pentene, and combinations thereof. In some embodiments, the comonomer is ethylene.

In some embodiments, polymer fraction (a) has a combination of the previously-described properties.

In some embodiments and in addition to one or more of the previously-described properties, the polymer fraction (a) has at least one of the following features:
a polydispersity index ranging from 3 to 10 or
solubility in xylene at 25° C. ranging from 0.5 to 8.0% by weight, alternatively from 1.0 to 7.0% by weight, based on the weight of the polymer fraction (a); or
an intrinsic viscosity of the fraction insoluble in xylene at 25° C. ranging from 1.2 to 1.9 dl/g. In some embodiments, polymer fraction (a) has a combination of the previously-described properties.

In some embodiments, the polymer fraction (b) has at least one the following features:
being made from or containing a copolymer of ethylene with a comonomer selected from propylene, butene-1, hexene-1 and combinations thereof; or
the amount of ethylene in the copolymer ranges from 20.0 to 38.0% by weight, alternatively from 23.0 to 35.0% by weight, based on the weight of the copolymer; or
solubility in xylene at 25° C. of no greater than 80% by weight, based on the weight of the polymer fraction (b); or
an intrinsic viscosity of the fraction soluble in xylene at 25° C. equal to or greater than 2.0 dl/g, alternatively ranging from 2.5 to 5.0 dl/g, alternatively from 2.8 to 4.0 dl/g. In some embodiments, the comonomer is propylene. In some embodiments, polymer fraction (b) has a combination of the previously-described properties.

In some embodiments and in addition to one or more of the previously-described properties, the polymer fraction (b) contains minor quantities, alternatively from 0.1 to 10.0% by weight, of units deriving from a diene, based on the weight of the copolymer. In some embodiments, the diene is selected from the group consisting of butadiene, 1,4-hexadiene, 1,5-hexadiene, ethylidene-1-norbornene and combinations thereof.

In some embodiments, the polypropylene composition (A) has at least one of the following features:
a total ethylene content ranging from 15.0 to 28.0% by weight, alternatively from 16.0 to 23.0% by weight, alternatively from 17.0 to 22.0% by weight, based on the sum of the weights of fraction (a)+fraction (b); or
a melt flow rate MFR(A) (ISO 1133-1:2011, 230° C./2.16 Kg) ranging from 0.3 to 1.0 g/10 min; or
a tensile modulus in MD, in TD, or both (ISO 527-1,-2) ranging from 60 to 130 MPa; or
a tensile stress at break in MD, in TD, or both (ISO 527-1,-2) ranging from 8 to 25 N/mm²; or
Shore A (ISO 868, 15 sec) higher than 80, alternatively from 90 to 120; or
Shore D (ISO 868, 15 sec) ranging from 25 to 40; or
a tear resistance in MD, in TD, or both (ASTM D1004) ranging from 50 to 100 N, alternatively from 60 to 90N. In some embodiments, polypropylene composition (A) has a combination of the previously-described properties.

In some embodiments and in addition to one or more of the previously-described properties, the polypropylene composition (A has at least one of the following features:
a flexural modulus (ISO 178:2010 measured on 1 mm-thick extruded sheets) equal to or lower than 150 MPa, alternatively ranging from 50 to 100 MPa; or
a Charpy impact strength at −20° C. (ISO 179-1:2010 eA) of from 80 to 120 KJ/m²; or
a puncture resistance (max force) ranging from 150 to 350 N, alternatively from 200 to 300 N, measured on a 1 mm-thick extruded sheet according to method ASTM D 4833 (punch diameter: 8 mm, crosshead speed: 300 mm/min); or
a puncture resistance (deformation at break) ranging from 20 to 80 mm, alternatively from 25 to 45 mm, measured on a 1 mm-thick extruded sheet according to method ASTM D 4833 (punch diameter: 8 mm, crosshead speed: 300 mm/min). In some embodiments, polypropylene composition (A) has a combination of the previously-described properties.

In some embodiments, the polypropylene composition (A) is prepared by polymerizing the relevant monomers in sequential polymerization stages, with the second and each optional subsequent polymerization stage being conducted in the presence of the polymeric material formed in the immediately preceding polymerization stage. In some embodiments, the polymer fraction (a) is prepared in a first polymerization stage and the polymer fraction (b) is prepared in a second polymerization stage, wherein each stage being carried out in the presence of the polymeric material prepared in the immediately preceding polymerization stage. In some embodiments, the amounts of fraction (a) and of fraction (b) correspond to the split between the polymerization stages. In some embodiments, each polymerization stage is executed in at least one polymerization reactor.

In some embodiments, the polymerization stages are carried out in the presence of a Ziegler-Natta catalyst. In some embodiments, the polymerization stages are carried out in the presence of a catalyst made from or containing the product of the reaction between:
i) a solid catalyst component made from or containing Ti, Mg, Cl, and an internal electron donor compound;
ii) an alkylaluminum compound; and
iii) an external electron-donor compound having the formula (R¹)ₐ(R²)_{b}Si(OR³)_{c}, where a and b are integers from 0 to 2, c is an integer from 1 to 4 and the sum (a+b+c) is 4; R¹, R², and R are independently selected from alkyl, cycloalkyl or aryl radicals with 1-18 carbon atoms, optionally containing heteroatoms.

In some embodiments, the internal donor is selected from the esters of mono or dicarboxylic organic acids such as benzoates, malonates, phthalates and certain succinates. In some embodiments, the internal donors are as described in U.S. Pat. No. 4,522,930, European Patent No. 045977A2 and Patent Cooperation Treaty Publication Nos. WO00/63261 and WO01/57099. In some embodiments, the internal donor is selected from the group consisting of phthalic acid esters. In some embodiments, the phthalic acid esters are selected from the group consisting of diisobutyl phthalate, dioctyl phthalate, diphenyl phthalate and benzyl-butyl phthalate.

In some embodiments, the particles of solid component (i) have substantially spherical morphology and average diameter ranging between 5 and 150 μm, alternatively from 20 to 100 μm, alternatively from 30 to 90 μm. As used herein, the term “substantially spherical morphology” refers to particles having the ratio between the greater axis and the smaller axis equal to or lower than 1.5, alternatively lower than 1.3.

In some embodiments, the solid catalyst component (i) is prepared by reacting a titanium compound of formula Ti(OR)q-yXy, where q is the valence of titanium and y is a number between 1 and q, with a magnesium chloride deriving from an adduct of formula MgCl₂·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100°-130° C.). Then, the adduct is mixed with an inert hydrocarbon immiscible with the adduct, thereby creating an emulsion which is quickly quenched causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (80°-130° C.), thereby obtaining an adduct wherein the number of moles of alcohol is of lower than 3, alternatively between 0.1 and 2.5. In some embodiments, the reaction with the Ti compound is carried out by suspending the adduct (dealcoholated or as such) in cold TiCl₄; the mixture is heated up to 80°-130° C. and maintained at this temperature for 0.5-2 hours. In some embodiments, the treatment with TiCl₄ is carried out one or more times. In some embodiments, the electron donor compound is added during the treatment with TiCl₄.

In some embodiments, the alkyl-Al compound (ii) is selected from the group consisting of trialkyl aluminum compounds, alkylaluminum halides, alkylaluminum hydrides, and alkylaluminum sesquichlorides. In some embodiments, the alkyl-Al compound (ii) is a trialkyl aluminum compound selected from the group consisting of triethylaluminum, triisobutylaluminum, tri-n-butylaluminum, tri-n-hexylaluminum, and tri-n-octylaluminum. In some embodiments, the alkyl-Al compound (ii) is an alkylaluminum sesquichloride selected from the group consisting of AlEt₂Cl and Al₂Et₃Cl₃. In some embodiments, the alkyl-Al compound (ii) is a mixture including trialkylaluminums. In some embodiments, the Al/Ti ratio is higher than 1, alternatively ranges between 50 and 2000.

In some embodiments, the silicon compounds (iii) are wherein a is 1, b is 1, c is 2, at least one of R¹ and R² is selected from branched alkyl, cycloalkyl or aryl groups with 3-10 carbon atoms, optionally containing heteroatoms, and R³ is a C1-C10 alkyl group. In some embodiments, R³ is methyl. In some embodiments, silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)(2-ethylpiperidinyl)dimethoxysilane, and methyl(3,3,3-trifluoro-n-propyl)dimethoxysilane.

In some embodiments, the silicon compounds are wherein a is 0, c is 3, R² is a branched alkyl or cycloalkyl group, optionally containing heteroatoms, and R³ is methyl. In some embodiments, the silicon compounds are selected from the group consisting of cyclohexyltrimethoxysilane, t-butyltrimethoxysilane and thexyltrimethoxysilane.

In some embodiments, the external electron donor compound (iii) provides a molar ratio between the alkylaluminum compound and the external electron donor compound (iii) of from 0.1 to 200, alternatively from 1 to 100, alternatively from 3 to 50.

In some embodiments, the polymerization processes for preparing the compositions are as described in EP472946A, the relevant part of which is incorporated herein by reference.

In some embodiments, the polymerization stages occur in gas phase. In some embodiments, the reaction temperature in the polymerization stage for the preparation of the polymer fraction (a) and in the preparation of the copolymer fraction (b) are the same or different. In some embodiments, the reaction temperatures are from 40° to 90° C. In some embodiments, the pressure of the polymerization stages to prepare the fractions (a) and (b) is from 5 to 30 bar. In some embodiments, the residence times relative to the two stages depend on the ratio between the fractions (a) and (b). In some embodiments, the residence times relative to the two stages range from 15 minutes to 8 hours. In some embodiments, the polymerization reactions use molecular weight regulators. In some embodiments, the molecular weight regulators are chain transfer agents. In some embodiments, the chain transfer agents are hydrogen or ZnEt₂.

In some embodiments, the final polypropylene composition is subjected to a chemical treatment with organic peroxides, thereby lowering the average molecular weight and increasing the melt flow index up to values for specified applications.

In some embodiments, the recycled ethylene polymer (B) originates from a pre-consumer waste, a post-consumer waste or from a combinations thereof. In some embodiments, the recycled ethylene polymer (B) originates from a post-consumer waste. In some embodiments, the recycled ethylene polymer (B) originates from the mechanical recycling of at least one of the above-mentioned waste streams.

In some embodiments, the recycled ethylene polymer (B) has a density ranging from 0.94 to 0.97 g/cm³, alternatively from 0.95 to 0.96 g/cm³, or a melt flow rate MFR(B) (ISO 1133-1:2011, 190° C./2.16 kg) ranging from 0.1 to 1.5 g/10 min., alternatively from 0.2 to 0.7 g/10 min, or both.

In some embodiments and in addition to one or more of the previously-described properties, the recycled ethylene polymer (B) has:
a tensile modulus (ISO 527-1,-2) equal to or greater than 1000 MPa, alternatively ranging from 1100 to 1500 MPa; or
a flexural modulus (ISO 178:2010 measured on compression molded plaques) ranging from 900 to 1500 MPa, alternatively from 1000 to 1400 MPa; or
an ash content (ISO 3451-1 at 600° C.) equal to or lower than 4% by weight, alternatively ranging from 0.5 to 3% by weight, based on the weight of the recycled ethylene polymer (B). In some embodiments, the recycled ethylene polymer (B) has a combination of the previously-described properties.

In some embodiments, the recycled ethylene polymer (B) is made from or containing a total amount up to and including 20% by weight, alternatively from 1 to 15% by weight, alternatively from 2 to 10% by weight, of recycled polypropylene, of an inorganic material, or both, based on the weight of the recycled ethylene polymer (B).

In some embodiments, the polyolefin composition (I) has at least one of the following features:
a melt flow rate MFR(I)(ISO 1133-1:2011, 230° C./2.16 kg) equal to or lower than 4.0 g/10 min, alternatively ranging from 0.1 to 3.0 g/10 min; or
Shore A (ISO 868, 15 sec) higher than 80, alternatively from 90 to 120; or
Shore D ISO 868, 15 sec) ranging from 25 to 40; or
a tensile modulus in MD or in TD (ISO 527-1,-2) greater than 100 MPa, alternatively ranging from more than 130 to 250 MPa.

In some embodiments and in addition to one or more of the previously-described properties, the polyolefin composition (I) has a tensile stress at break satisfying the inequality

$$\vert S b ( I ) - S b ( A ) \vert \leq 3. , alternatively \leq 2.$$

wherein Sb(I) is the mean value of the tensile stress at break of the polyolefin composition (I) and Sb(A) is the mean value of the tensile stress at break of the polypropylene composition (A).

The mean value of tensile stress at break is calculated with the formula (Sb(MD)+Sb(TD))/2, wherein Sb(MD) and Sb(TD) are the values of the tensile strength at break in MD and TD, respectively.

In some embodiments, the polyolefin composition (I) has welding properties as indicated by maximum seal strength and elongation. In some embodiments, the polyolefin composition (I) has a maximum seal strength, measured according to the method ASTM D 6392-08, equal to or greater than 200 N/25 mm, alternatively ranging from 200 to 300 N/25 mm. In some embodiments, the polyolefin composition (I) has an elongation, according to the method ASTM D 6392-08, equal to or greater than 700%, alternatively ranging from 700% to 850%, alternatively from 720% to 800%.

In some embodiments, the polyolefin composition (I) is further made from or containing up to and including 5.0% by weight, alternatively from 0.01% to 5.0% by weight, of an additive (C); or up to and including 30% by weight, alternatively from 1.0 to 30% by weight, of a filler (D), or both, wherein the amounts of (C) and (D) are based on the total weight of the polyolefin composition (I).

In some embodiments, the additive (C) is selected from the group consisting of nucleating agents, anti-oxidants, light stabilizers, slipping agents, anti-acids, melt stabilizers, and combinations thereof, the amount of additive being based on the total weight of the polyolefin compositions (I).

In some embodiments, the filler (D) is selected from the group consisting of inorganic fillers; natural fillers; and mineral fillers. In some embodiments, the inorganic fillers are glass fibers or carbon fibers. In some embodiments, the natural fillers are wood or hemp. In some embodiments, the mineral filler is talc.

In some embodiments, the polyolefin composition (I) consists of the component (A), the component (B), optionally the additive (C) and optionally the filler (D).

In some embodiments, the polyolefin composition (I) is obtained by mixing the components (A), (B) and optionally (C), (D), or both, in a melt mixing apparatus. In some embodiments, the melt-mixing apparatus is a single or twin screw extruder.

In some embodiments, the present disclosure provides an extruded article made from or containing the polyolefin composition (I). In some embodiments, the present disclosure provides cast article made from or containing the polyolefin composition (I).

In some embodiments, the extruded article is a film or sheet. In some embodiments, the film or sheet is used for roofing applications.

In some embodiments, the features are not inextricably linked to each other. In some embodiments, ranges of a feature are combined with ranges of a different feature, independently.

### EXAMPLES

The following examples are given to illustrate the present disclosure, without limiting purpose.

### Characterization Methods:

Melt Flow Rate: Determined according to the method ISO 1133-1:2011 (230° C./2.16 kg for the propylene polymers and for the polyolefin composition (I) and 190° C./2.16 kg for polyethylene).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes, and maintained at 25° C. with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XSA values were experimentally determined. The fraction of component (B) soluble in xylene at 25° C. (XSB) was calculated from the formula:

$$X S = W ( A ) \times ( X {S}_{A} ) + W ( B ) \times ( X {S}_{B} )$$

wherein W(A) and W(B) are the relative amounts of components (A) and (B), respectively, and W(A)+W(B)=1.

Intrinsic viscosity of the xylene soluble fraction: To calculate the value of the intrinsic viscosity IV, the flow time of a polymer solution was compared with the flow time of the solvent tetrahydronaphthalene (THN). A glass capillary viscometer of Ubbelohde type was used. The oven temperature was adjusted to 135° C. Before starting the measurement of the solvent flow time t0, the temperature was stable (135±0.2° C.). Sample meniscus detection for the viscometer was performed by a photoelectric device.

Sample preparation: 100 ml of the filtered solution (S1) was poured into a beaker, and 200 ml of acetone were added under vigorous stirring. Precipitation of insoluble fraction was complete as evidenced by a clear solid-solution separation. The suspension was filtered on a weighed metallic screen (200 mesh). The beaker was rinsed. The precipitate was washed with acetone, thereby removing the o-xylene. The precipitate was dried in a vacuum oven at 70° C. until a constant weight was reached. 0.05 g of precipitate were dissolved in 50 ml of tetrahydronaphthalene (THN) at a temperature of 135° C. The efflux time t of the sample solution was measured and converted into a value of intrinsic viscosity [η] using Huggins' equation (Huggins, M. L., J. Am. Chem. Soc. 1942, 64, 11, 2716-2718) and the following data:
concentration (g/dl) of the sample;
the density of the solvent at a temperature of 135° C.; and
the flow time t0 of the solvent at a temperature of 135° C. on the same viscometer.

A single polymer solution was used to determine [η].

Ethylene content of propylene-ethylene copolymers by NMR: ¹³C NMR spectra were acquired on a Bruker AV-600 spectrometer equipped with cryoprobe, operating at 160.91 MHz in the Fourier transform mode at 120° C. The peak of the Sββ carbon (nomenclature according to “Monomer Sequence Distribution in Ethylene-Propylene Rubber Measured by 13C NMR. 3. Use of Reaction Probability Mode”, C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz. The assignments of the spectra, the evaluation of triad distribution and the composition were made according to Kakugo (“Carbon-13 NMR determination of monomer sequence distribution in ethylene-propylene copolymers prepared with 6-titanium trichloride-diethylaluminum chloride” M. Kakugo, Y. Naito, K. Mizunuma and T. Miyatake, Macromolecules, 1982, 15, 1150) using the following equations:

$$PPP = 100 T ββ / S PPE = 100 T βδ / S EPE = 100 T δδ / S$$

$$PEP = 100 S ββ / S PEE = 100 S βδ / S EEE = 100 ( 0.25 S γδ + 0.5 S δδ ) / S$$

$$S = T ββ + T β δ + T δ δ + S β β + S β δ + 0.25 S γδ + 0.5 S δδ$$

The molar percentage of ethylene content was evaluated using the following equation:

$$E \% mol = 100 * [ PEP + PEE + EEE ]$$

The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁/r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

Polydispersity index: Determined at a temperature of 200° C. by using a parallel plates rheometer model RMS-800 marketed by Rheometrics (USA), operating at an oscillation frequency which increased from 0.1 rad/sec to 100 rad/sec. From the crossover modulus, the P.I. was derived from the equation:

$$P . I . = 105 / Gc$$

wherein Gc is the crossover modulus which is defined as the value (expressed in Pa) at which G′=G″ wherein G′ is the storage modulus and G″ is the loss modulus.

Density: determined according to ISO 1183-1/A:2019 at 23° C.

Tensile properties: determined according to ISO 527-1, -2 on 1 mm-thick extruded sheets for the PP(A) and the polyolefin composition (I), and on compression molded plaques for the recycled polyethylene (B).

Shore A and Shore D: determined according to ISO 868, 15.sec.

Tear resistance: determined according to ASTM D1004 on 1 mm-thick extruded sheets. Crosshead speed: 51 mm/min; V-shaped die cut specimen.

Ash content: determined with the method ISO 3451-1 at 600° C.

Flexural Modulus: determined according to the method ISO 178:2010.

Charpy impact strength: determined according to ISO 179-1:2010 eA on 1 mm-thick extruded sheets.

Puncture resistance: measured on a 1 mm-thick extruded sheet according to method ASTM D 4833 (punch diameter: 8 mm, crosshead speed: 300 mm/min).

Preparation of extruded specimens: the polymer in form of granules were fed via feed hoppers into a Leonard extruder (mono-screw extruder, 40 mm in diameter and 27 L/D in length) where the polymer was first melted (melt temperature 230° C.), compressed, mixed and finally metered out at a throughput rate of 10 Kg/h with a metering pump (15 cc/rpm). The molten polymer left the flat die (width 200 mm, die lip at 0.8-0.9 mm) and was instantly cooled through a vertical three-rolls calender, having roll-temperature of 60° C. 1 mm-thick extruded sheets were obtained.

Preparation of compression molded specimens: according to the method ISO 293, with the conditions in DIN EN ISO 17855-2.

Welding properties: measured with the test method ASTM D 6392-08, applying the following conditions: specimen width=25 mm; thickness=1 mm and gauge length=50 mm. A seam was obtained by welding together two pieces of sheet 1 mm-thick and 150×200 (mm) of dimensions. The seam was about 30 mm large, and the added weight was 5400 g. The temperature of the weld was set at 280° C. (hot air direct measure). A seam strength curve was acquired. The maximum strength, the average strength and the type of breakage were recorded. The testing speed was 3 m/min (T-Peel). The values, indicated in the tables, were the mean values obtained by testing 5 samples for each material.

### Raw Materials

PP(A): the polypropylene composition (A) was prepared according to the procedure reported in in comparative example 2 of Patent Cooperation Treaty Publication No. WO2022/017758A1. The polypropylene composition (A) was made from or containing
30% by weight of a polymer fraction (a)
   i) made from or containing a propylene-ethylene copolymer containing 3.2% by weight of units derived from ethylene, based on the weight of the fraction (a),
   ii) having solubility in xylene at 25° C. of 6.0% by weight, based on the weight of fraction (a), and
   iii) having a MFR(a) of 25 g/10 min. (ISO1133-1:2011, 230° C./2.16 Kg); and
70% by weight of a polymer fraction (b)
   i) made from or containing an ethylene-propylene copolymer containing 27% by weight of units derived from ethylene, based on the weight of the fraction (b), and
   ii) having solubility in xylene at 25° C. of 64% by weight, based on the weight of the fraction (b), wherein the fraction soluble in xylene having intrinsic viscosity of 3.2 dl/g,
      wherein the amounts of polymer fraction (a) and (b) are based on the sum of the weights of fraction (a)+fraction (b). The characterization of the composition is reported in table 1.

The polymer was further made from or containing additives in the amounts of 0.05 wt. % calcium stearate, 0.05 wt. % of Irganox 1010 (pentaerythritol tetrakis(3-(3,5-di-tert-butyl-4-hydroxyphenyl)propionate)) and 0.1 wt. % of Irgafos 168 (tris(2,4-di-tert-butylphenyl) phosphite). The Irganox 1010 and the Irgafos 168 was commercially available from BASF.

rPE: a recycled ethylene polymer, having density of 0.956 g/cm³, MFR of 0.3 g/10 min (ISO1133-1:2011, 190° C./2.16 Kg), and originating from mechanical recycling of pre-sorted municipal plastic waste was used as component (B). The rPE had a tensile modulus of 1200 MPa, a flexural modulus of 1400 MPa and an ash content of less than 2% by weight. The rPE was made from or containing about 4% by weight of recycled polypropylene.

### Example 1

15% by weight of rPE was melt blended with 85% by weight of the polypropylene composition (A) in a Berstorff three twin screw extruder, at a rotation speed of 250 rpm and a melt temperature of 200-250° C. The mechanical properties of the polyolefin composition (I) are reported in Table 1 and compared with the properties of the polypropylene composition (A).

TABLE 1

| | | | PP(A) | Ex. 1 |
|---|---|---|---|---|
| MFR (230° C./2.16 Kg) | | g/10 min | 0.52 | 0.59 |
| Tensile modulus | MD | MPa | 130 | 150 |
| | TD | MPa | 98 | 100 |
| Tensile stress at break | MD | MPa | 19.0 | 17.9 |
| | TD | MPa | 18.4 | 16.6 |
| Tensile stress at yield | MD | MPa | NY | 7.90 |
| | TD | MPa | 6.2 | 6.5 |
| Flexural modulus | | MPa | 90 | — |
| Charpy impact strength - notched | | kJ/m² | 110 | — |
| (−20° C.) | | | | |
| Shore A | | | >90 | >90 |
| Shore D | | | 33 | 31 |
| Tear resistance | MD | N | 76 | 78 |
| | TD | N | 75 | 85 |

| | | | |
|---|---|---|---|
| Puncture resistance (max force) | N | 257 | 260 |
| Puncture resistance (deformation) | mm | 46 | 41 |

Welding properties

| | | | |
|---|---|---|---|
| max strength | N/25 mm | 186 | 213 |
| average peeling/shear | N/mm | 6.4 | 7.4 |
| max peeling/shear | N/mm | 7.4 | 8.5 |
| max elongation | % | 640 | 750 |

NY: No Yield

What is claimed is:

1. A polyolefin composition (I) comprising:
(A) from 65 to 95% by weight of a polypropylene composition,
having a melt flow rate MFR(A) (ISO 1133-1:2011, 230° C./2.16 kg) ranging from 0.2 to 1.2 g/10 min, and
comprising:
a) from 15 to 40% by weight of a polymer fraction (a) comprising
i) a propylene polymer selected from a propylene homopolymer, a propylene copolymer and combinations thereof,
wherein the propylene copolymer containing up to and including 15.0% by weight of units derived from a comonomer selected from ethylene, a CH₂═CHR alpha-olefin, where R is a linear or branched C2-C8 alkyl group, and combinations thereof, based on the weight of the polymer fraction (a), and
ii) having solubility in xylene at 25° C. XS(a) equal to or lower than 10.0% by weight, based on the weight of the polymer fraction (a); and
b) from 60 to 85% by weight of a polymer fraction (b) comprising
i) a copolymer of ethylene with a comonomer selected from propylene, a CH₂═CHR alpha-olefin, where R is a linear or branched C2-C8 alkyl group, and combinations thereof,
wherein the copolymer containing an amount of units deriving from ethylene equal to or lower than 40% by weight, based on the weight of the polymer fraction (b), and
ii) having solubility in xylene at 25° C. XS(b) equal to or greater than 60% by weight, based on the weight of the polymer fraction (b),
wherein the amounts of fractions (a) and (b) are based on the sum of the weights of fraction (a)+fraction (b); and
(B) from 5 to 35% by weight of a recycled ethylene polymer,
having a density equal to or greater than 0.94 g/cm³ and
a melt flow rate MFR(B) ranging from 0.05 to 10.0 g/10 min. (ISO 1133-1:2011, 190° C./2.16 kg),
wherein the amounts of (A) and (B) are based on the total weight of (A)+(B).

2. The polyolefin composition (I) according to claim 1 comprising:
from 70 to 93% by weight of the polypropylene composition (A), and
from 7 to 30% by weight of the recycled ethylene polymer (B),
wherein the amounts of (A) and (B) are based on the total weight of (A)+(B).

3. The polyolefin composition (I) according to claim 1, wherein the polymer fraction (a) has at least one of the following features:
comprising a propylene copolymer containing from 0.5 to 10.0% by weight of a comonomer selected from ethylene, a CH₂═CHR alpha-olefin, where R is a linear or branched C2-C8 alkyl group, and combinations thereof, based on the weight of the fraction (a);
a melt flow rate MFR(a) (ISO 1133-1:2011, 230° C./2.16 kg) ranging from 10 to 50 g/10 min.

4. The polyolefin composition (I) according to claim 1, wherein the polymer fraction (b) has at least one of the following features:
comprising a copolymer of ethylene with a comonomer selected from propylene, butene-1, hexene-1 and combinations thereof; or
the amount of ethylene in the copolymer ranges from 20.0 to 38.0% by weight, based on the weight of the copolymer; or
solubility in xylene at 25° C. of no greater than 80% by weight, based on the weight of the polymer fraction (b); or
an intrinsic viscosity of the fraction soluble in xylene at 25° C. equal to or greater than 2.0 dl/g.

5. The polyolefin composition (I) according to claim 1, wherein the polypropylene composition (A) has at least one of the following features:
a total ethylene content ranging from 15.0 to 28.0% by weight, based on the sum of the weights of fraction (a)+fraction (b); or
a melt flow rate MFR(A) (ISO 1133-1:2011, 230° C./2.16 Kg) ranging from 0.3 to 1.0 g/10 min; or
a tensile modulus in TD, in MD, or both (ISO 527-1,-2) ranging from 60 to 130 MPa; or
a tensile stress at break in TD, in MD, or both (ISO 527-1,-2) ranging from 8 to 25 N/mm²; or
Shore A (ISO 868, 15 sec) higher than 80; or
Shore D (ISO 868, 15 sec) ranging from 25 to 40; or
a tear resistance in MD, in TD, or both (ASTM D1004) ranging from 50 to 100 N more.

6. The polyolefin composition (I) according to claim 1, wherein the recycled ethylene polymer (B) has a density ranging from 0.94 to 0.97 g/cm³, or a melt flow rate MFR(B) (ISO 1133-1:2011, 190° C./2.16 kg) ranging from 0.1 to 1.5 g/10 min, or both.

7. The polyolefin composition (I) according to claim 1, wherein the recycled ethylene polymer (B) has:
a tensile modulus (ISO 527-1,-2) equal to or greater than 1000 MPa; or
a flexural modulus (ISO 178:2010 measured on compression molded plaques) ranging from 900 to 1500 MPa; or
an ash content (ISO 3451-1) equal to or lower than 4% by weight, based on the weight of the recycled ethylene polymer (B).

8. The polyolefin composition (I) according to claim 1, wherein the recycled ethylene polymer (B) comprises a total amount up to and including 20% by weight of recycled polypropylene, an inorganic material, or both, based on the weight of the recycled ethylene polymer (B).

9. The polyolefin composition (I) according to claim 1, having at least one of the following features:
a melt flow rate MFR(I) (ISO 1133-1:2011, 230° C./2.16 kg) equal to or lower than 4.0 g/10 min; or
Shore A (ISO 868, 15 sec) higher than 80; or
Shore D (ISO 868, 15 sec) ranging from 25 to 40; or
a tensile modulus in MD or in TD (ISO 527-3) greater than 100 MPa.

10. An extruded article comprising the polyolefin composition (I) according to claim 1.

11. The extruded article according to claim 10, wherein the article is a film or sheet for roofing applications.
